(19) United States
(12) Patent Application Publication
(10) Pub. No.: US 2002/0153741 A1
(43) Pub. Date: Oct. 24, 2002

(54) Instrument panel and method of manufacture

(76) Inventors: Phillip Brian Speelman, Miami TWP., OH (US); Mark Brian Wolfe, Vandalia, OH (US)

Correspondence Address: KATHRYN A. MARRA, DELPHI TECHNOLOGIES, INC., Legal Staff, Mail Code: 480-414-420, P.O. Box 5052, Troy, MI, 48007-5052, US

(21) Appl. No.: 09/879,611

(22) Filed: Jun. 12, 2001

Related U.S. Application Data
(60) Provisional application No. 60/269,960, filed on Feb. 20, 2001.

(51) Int. Cl. B62D 25/14

(52) U.S. Cl. 296/70

(57) ABSTRACT

An instrument panel section connectable to a retainer of a vehicle, the retainer includes locator holes disposed therein. The instrument panel section has a layer of foam and a skin. The foam has a first surface, a second surface, a first end and a second end opposite the first end. The skin has an exterior surface and an interior surface. The interior surface is bonded to the second surface. The skin is wrapped around and bonded to the first and second ends. Connecting protrusions for connecting and aligning the instrument panel section with respect to the retainer extend from the first surface adjacent the first end. The first surface is adhesively bondable to the retainer such that the connecting protrusion is receivable in one of the locator holes.

### CROSS REFERENCE TO RELATED APPLICATION

This application claims the benefit of provisional application serial No. 60/269,960 filed on Feb. 20, 2001, the contents of which are incorporated by reference.

### TECHNICAL FIELD

This application relates generally to the field of instrument panels for a vehicle. More specifically, this application relates to instrument panels having unique self aligning connections which enable interconnection of instrument panels having different surface features, such as color, texture, materials, die-draw.

### BACKGROUND

Instrument panels having multiple surface features, such as color, texture, materials, die-draw, are often desirable. Such sections are used to delineate sun bearing from non-sun-bearing surfaces or to delineate such things as airbags and the like.

In order to make a two-color or two-tone instrument panel, a single tone conventional instrument panel section is manufactured and the second tone was then added. Typically, the second tone was added through a painting operation. In this type of operation, the single tone conventional instrument panel section is masked or covered in specific areas, and then paint is applied to the un masked portions. As such, two-tone instrument panels have required large investment in paint facilities and often led to higher than desirable scrap rate of parts. Additionally, single tone instrument panels, molding tools, and application processes require expensive and time-consuming steps. Moreover, this technique for manufacturing two-tone instrument panels adds additional complexity, cost and scrap to the single tone manufacturing process.

### SUMMARY

A method is provided for manufacturing cost effective instrument panels using self-aligning connections that enable interconnection of instrument panels having different surface features, such as color, texture, materials, die-draw.

An instrument panel section connectable to an instrument panel retainer of a vehicle's instrument panel assembly, the retainer includes locator holes disposed therein. The instrument panel section has a layer of foam and a skin. The foam has a first surface, a second surface, a first end and a second end, opposite the first end. The skin has an exterior surface and an interior surface. The interior surface is bonded to the second surface of the foam. The skin is wrapped around and bonded to the first and second ends. Connecting protrusions for connecting and aligning the instrument panel section with respect to the retainer extend from the first surface adjacent the first end. The first surface is adhesively bondable to the retainer such that the connecting protrusion is receivable in the locator hole.

An instrument panel assembly connected to an instrument panel retainer of a vehicle, the retainer including locator holes disposed therein. The instrument panel assembly includes first and second instrument panel sections. The first instrument panel section has a layer of foam and a skin. The foam has a first surface, a second surface, and a first end. The skin has a first exterior surface and an interior surface. The interior surface is bonded to the second surface and the skin is wrapped around and bonded to the first end. The foam includes at least one connecting protrusion extending from the first surface adjacent the first end. The second instrument panel section also has a layer of foam and a skin. The foam has a first surface, a second surface, and a second end. The skin has a second exterior surface and an interior surface. The second exterior surface is different than the first exterior surface. The interior surface is bonded to the second surface and the skin is wrapped around and bonded to the second end, defining a flap of skin. The first end abuts the second end with the flap tucked under the first end. The first surfaces of the first and second instrument panels are adhesively bonded to the retainer. The flap is wrapped about the connecting protrusion, which are then both received in one of the locator holes.

A method of aligning and interconnecting a first instrument panel section and a second instrument panel section with an instrument panel retainer of a vehicle's instrument panel assembly, the retainer includes at least one locator hole. The method includes abutting a first end of a first instrument panel section with a second end of a second instrument panel section; tucking a flap under the first end; urging a connecting protrusion on the flap and into the locator hole to align and connect the first instrument panel section, the second instrument panel section and the retainer; and bonding the first and second instrument panel sections to the retainer with an adhesive. The first instrument panel section has a layer of foam and a skin. The foam has a first surface, a second surface, and a first end. The skin has a first exterior surface and an interior surface. The interior surface is bonded to the second surface and the skin is wrapped around and bonded to the first end. The foam includes at least one connecting protrusion extending from the first surface adjacent the first end. The second instrument panel section also has a layer of foam and a skin. The foam has a first surface, a second surface, and a second end. The skin has a second exterior surface and an interior surface. The second exterior surface is different than the first exterior surface. The interior surface is bonded to the second surface and the skin is wrapped around and bonded to the second end, defining a flap of skin.

The above-described and other features and advantages of the present invention will be appreciated and understood by those skilled in the art from the following detailed description, drawings, and appended claims.

### BRIEF DESCRIPTION OF THE DRAWINGS

FIG. 1 is a partial cross-section exploded view of a single tone instrument panel section;

FIG. 2 is a partial cross-section exploded view of a conventional single tone instrument panel section in a molding tool;

FIG. 3 is a partial exploded cross-section view of an exemplary embodiment of an instrument panel section;

FIG. 4 is a partial cross-section exploded view of a first exemplary embodiment of a molding tool for molding the single tone instrument panel section of FIG. 3;

FIG. 5 is a partial cross-section exploded view of a second exemplary embodiment of a molding tool for molding the single tone instrument panel section of FIG. 3;

FIG. 6 is a front perspective view of an exemplary two-tone instrument panel assembly;

FIG. 7 is a partial cross-section view of the two-tone instrument panel assembly of FIG. 6, taken along lines 7-7;

FIG. 8 is a partial cross-section view of the two-tone instrument panel assembly of FIG. 6, taken along lines 8-8; and

FIG. 9 is a partial cross-section view of the two-tone instrument panel assembly of FIG. 6, taken along lines 9-9.

### DESCRIPTION OF THE PREFERRED EMBODIMENT

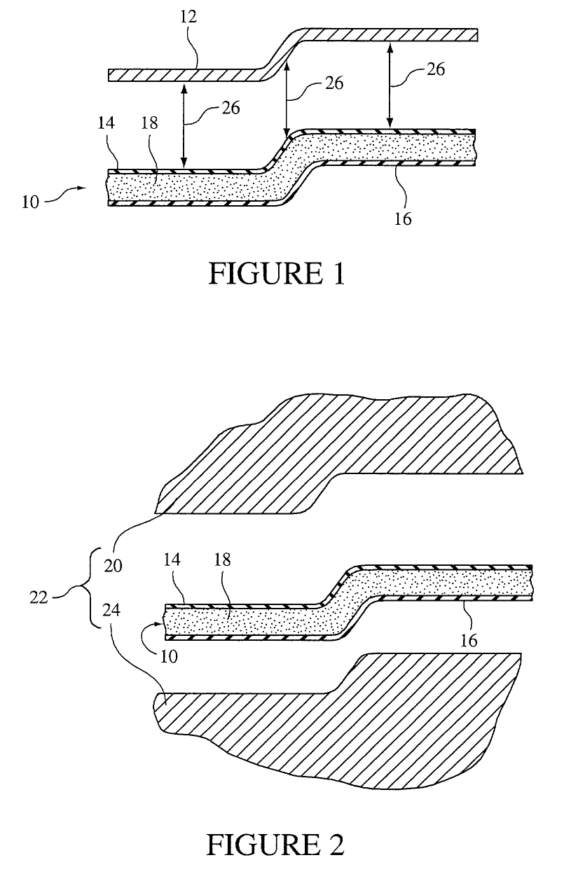

Referring to the Figures and particularly to FIGS. 1 and 2, an instrument panel section 10 and its method of manufacture are illustrated. An instrument panel retainer 12 for supporting instrument panel section 10 has a desired shape. As it is used in this application, retainer 12 refers generally to a rigid support structure defining the general size and shape of an instrument panel for a vehicle. Such a retainer supports components used to control various vehicle systems, display panels, ventilation outlets, storage compartments, safety features, and the like. Moreover, such a retainer often time provides structural support to the vehicle. Retainer 12 is connectable to a structural beam (not shown) of the vehicle.

Instrument panel section 10 includes a liner 14, a skin 16, and a foam layer 18. Liner 14 is polyvinyl chloride (PVC) material and i vacuum formed to match the contours of retainer 12. Liner 14 is matingly engaged with a first mold portion 20 of a molding tool 22. Skin 16 is placed in the second mold portion 24 of molding tool 22. The contours of the second mold portion 24 define the configuration of the exterior surface of the skin 16 that will be visible to occupants of the vehicle. Foam 18, typically urethane foam padding, is introduced into and fills the gap between liner 14 and skin 16. Liner 14 is required so that foam 18 does not stick to first mold portion 20. Instrument panel section 10 is removed from molding tool 22 and trimmed as necessary. Thus, instrument panel section 10 is configured according to the contours defined by first mold portion 20 and second mold portion 24 to match retainer 12.

Instrument panel section 10 is applied to retaining 12 using an application process that includes adhering liner 14 to retainer 12 using a two-component methyl methacrylate adhesive 26. Thus, foam-padding 18 provides a layer of resilient padding between skin 16 and retainer 12.

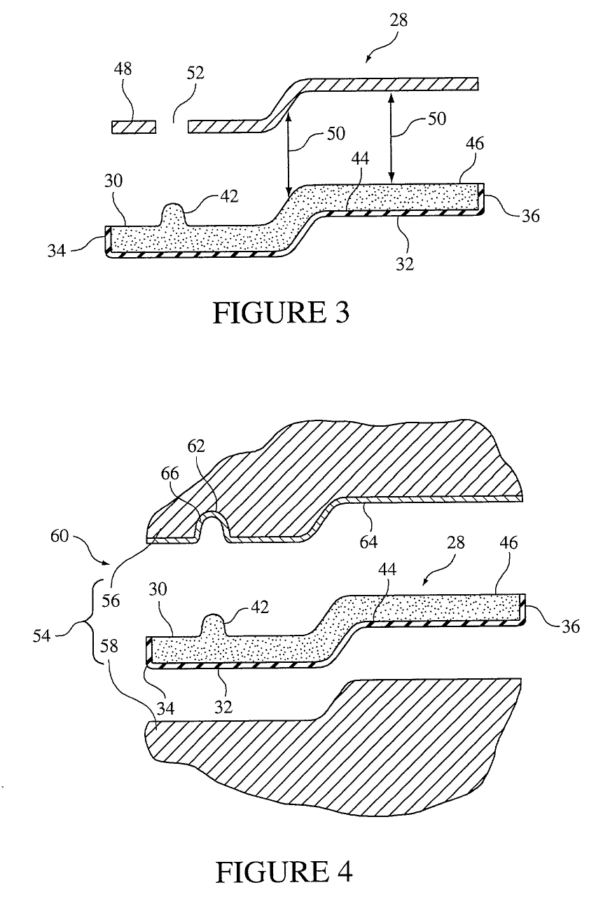

Referring now to FIG. 3, an exemplary embodiment of an instrument panel section 28 is illustrated. Instrument panel section 28 includes a layer of foam 30 bonded to a skin 32. Skin 32 presents an exterior surface opposite foam 30 that will be visible to occupants of a vehicle and an interior surface that will be bonded to foam 30. Foam 30 is connected to an instrument panel retainer 48 of the vehicle's instrument panel assembly and to skin 32. Thus, conventional liner 14 discussed above has been eliminated.

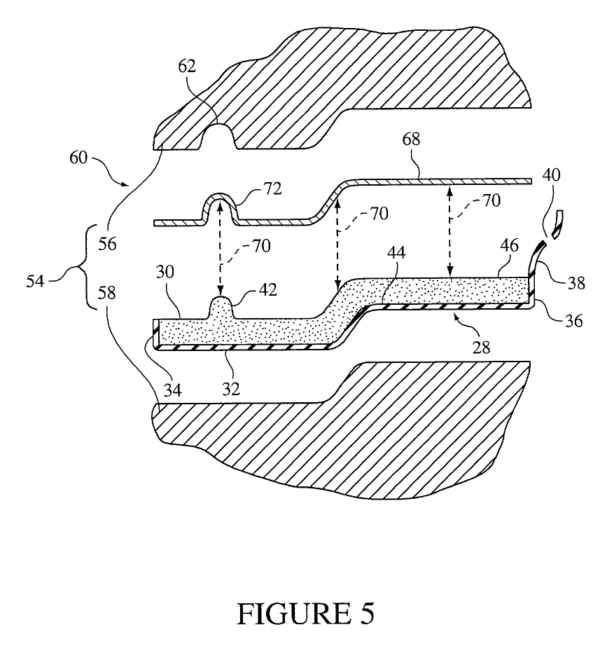

Skin 32 is a material such as, but not limited to, polyvinyl chloride based vinyl, thermo-polyolefin, thermo-polyurethane (TPU), sprayed-urethane, foam-backed polyvinyl chloride or foam-backed thermo-polyolefin. Skin 32 presents an aesthetically pleasing appearance to the user, yet resists damage as a consequence of exposure to environmental factors such as, but not limited to sunlight, moisture, temperature variation, and the like. Skin 32 wraps around foam 30 at ends 34 and 36. Additionally, in at least some portions of instrument panel section 28, end 36 of skin 32 includes a flap 38 that extends beyond foam 30 as illustrated in FIG. 5. Preferably, flap 38 includes an aperture 40 adapted to receive connecting protrusions 42 described below. For purposes of clarity, skin 32 is described herein as having two ends 34 and 36, however the skin, depending on its geometric shape, has more than two ends. Thus, skin 32 having more than two ends are considered within the scope of the present invention.

Foam 30 is sufficiently porous and resiliently deformable to provide cushioning and to absorb impact energy. Thus, foam 30 provides a layer of resilient padding for skin 32. Preferably, foam 30 includes a first side 44 adapted to be bonded to skin 32 and a second side 46 adapted to be connected to retainer 48. Second side 46 is adapted to be connected to retainer 48 via an adhesive 50 and a plurality of connecting protrusions 42 adapted to mate with a plurality of locator holes 52 formed in the retainer.

In an exemplary embodiment, foam 30 is a urethane foam and adhesive 50 is a reactive water-based polyurethane hot melt glue, such as, but not limited to, PUR Hot Melt manufactured by National Starch and Chemical Company. Alternative adhesives 50 include PUR Hot Melts from alternate suppliers. Generally, adhesive 50 is pressure sensitive and adapted to bond with both foam 30 and retainer 48.

Exemplary embodiments of a molding tool 54 used for manufacturing instrument panel section 28 are illustrated in FIGS. 4 and 5. Generally, molding tool 54 includes a first mold portion 56 and a second mold portion 58. First mold portion 56 and second mold portion 58 define a mold cavity 60 for forming instrument panel section 28. First mold portion 56 includes a plurality of depressions 62 formed therein adapted to form a plurality of connecting protrusions 42 on foam 30.

A first exemplary embodiment of molding tool 54 is provided in FIG. 4. First mold portion 56 includes a coating 64 that resists adhesion of foam 30. More specifically, coating 64 comes into contact with second side 46 of foam 30 and the coating prevents the adhesion of the first side to first mold portion 56. Coating 64 includes a depression area 66 that extends into and coats depression 62. Preferably, first mold portion 56 is an aluminum alloy and coating 64 is a polytetraflouroethylene (PTFE) based material. Thus, coating 64 and first mold portion 56 resists the adhesion of foam 30 during manufacture allowing instrument panel section 28 to be cleanly stripped from molding tool 54.

A second exemplary embodiment of molding tool 54 is provided in FIG. 5. First mold portion 56 includes a sheet 68 that separates foam 30 from the first mold portion. The material of sheet 68 is readily separable from foam 30 and from first mold portion 56. A minimal bond 70 is formed between sheet 68 and second side 46 of foam 30. Moreover, sheet 68 resists bonding to first mold portion 56. Sheet 68 includes a depression area 72 that extends into and covers depression 62. Breaking minimal bond 70 results in insignificant damage to foam 30 and removing sheet 68 from first molding portion 56 results in insignificant damage to the sheet. Thus, sheet 68 is adapted to be reusable or recyclable such that the sheet may be used a plurality times. Preferably, sheet 68 is a polyethylene-based material.

Instrument panel section 28 is formed by initially placing skin 32 on second mold portion 58 and by injecting foam 30 into mold cavity 60. Foam 30 fills mold cavity 60 such that first side 44 adheres to skin 32 and such that second side contacts coating 64 or sheet 68. Additionally, first side 44 adheres to skin 32 at ends 34 and 36. Foam 30 sets in mold cavity 60 such that skin 32 is in contact with second mold portion 58, thus defining the desired contours and aesthetically pleasing appearance of the skin that will be visible to an operator. Concurrently, foam 30 conforms to first mold portion 56, thus defining protrusions 42. After foam 30 has set or cured, first mold portion 56 and second mold portion 58 are separated from one another and instrument panel section 28 is stripped cleanly from mold cavity 60.

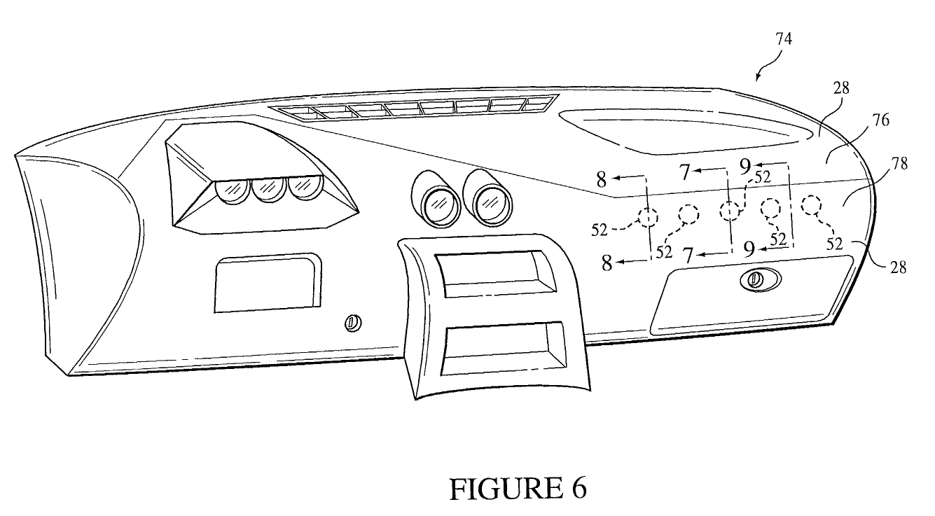

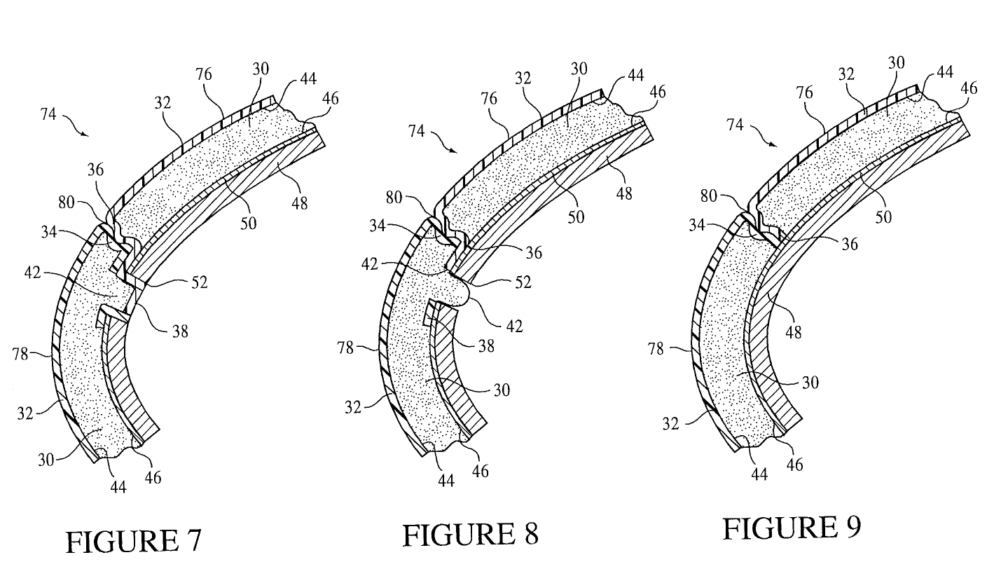

An exemplary embodiment of a two-tone instrument panel assembly 74 is shown in FIGS. 6 through 9. Instrument panel assembly 74 includes two instrument panel sections 28, namely a first section 76 and a second section 78. First section 76 and second section 78 are aligned with respect to one another and with respect to retainer 48 prior to adhering the instrument panel sections to the retainer using adhesive 50. Locator holes 52 formed in retainer 48 are shown in phantom in FIG. 6. For purposes of clarity five locator holes 52 are shown, however any number of locator holes sufficient to assemble and aligning first section 76 and second section 78 with respect to retainer 52 are considered within the scope of the present invention. FIGS. 7 and 8 illustrates different exemplary embodiments for connecting protrusions 42 and locator holes 52, while FIG. 9 illustrates an exemplary embodiment areas having no connecting protrusion 42 or locator hole 52. Preferably, first section 76 and second section 78 have skins 32 providing different surface features to the occupant, such as, but not limited to, color, texture, materials, die-draw, and the like.

FIG. 7 details a first exemplary embodiment of the connection between first section 76, second section 78 and retainer 48. End 34 of second section 78 is butted against end 36 of first section 76. Flap 38 is tucked underneath second section 78 adjacent second side 46 of the foam. Connecting protrusion 42 is inserted in locator hole 52 of retainer 48 such that flap 38 is wrapped about the connecting protrusion forming an interference connection between the interface of the hole, the protrusion and the flap. Adhesive 50 further connects first section 76, second section 78 and retainer 48 to form instrument panel 74.

FIG. 8 details an alternate exemplary embodiment of the connection between first section 76, second section 78 and retainer 48. Similar to the connection described with respect to FIG. 7, end 34 of second section 78 is butted against end 36 of first section 76 and flap 38 is tucked underneath the second section adjacent second side 46 of the foam. However, in this embodiment flap 38 includes aperture 40, which corresponds to the placement of hole 52 and protrusion 42. Thus, protrusion 42 is insertable through aperture 40 into locator hole 52 of retainer 48 such that an interference connection is formed between the interface of the hole and the protrusion. Again, adhesive 50 further connects first section 76, second section 78 and retainer 48 to form instrument panel 74.

FIG. 9 details an exemplary embodiment of the connection between first section 76, second section 78 and retainer 48 in areas having no connecting protrusions 42 or locator holes 52. In these areas,end 34 of second section 78 is butted against end 36 of first section 76. Since end 36 terminates at foam 30 (i.e., no flap 38 is present), none of skin 32 is tucked underneath second section 46. As also shown in FIGS. 7 through 9, end 36 and end 34 also preferably include skin lock contours 80 adapted to increase the security of the connection between first section 76 and second section 78.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An instrument panel section connectable to a retainer of a vehicle, comprising:
a layer of foam having a first surface, a second surface, a first end and a second end, wherein said second end is opposite said first end;
a skin including an exterior surface and an interior surface, said interior surface of said skin being bonded to said second surface of said foam and said skin being wrapped around and bonded to said first end and said second end; and
at least one connecting protrusion for connecting and aligning the instrument panel section with respect to the retainer extends from said first surface adjacent said first end, said first surface being adhesively bondable to the retainer such that said at least one connecting protrusion is receivable in a locator hole of the retainer.

2. The instrument panel section of claim 1, wherein said at least one connecting protrusion is integral with and part of said layer of foam.

3. The instrument panel section of claim 1, wherein said skin is selected from the group consisting of polyvinyl chloride based vinyl, thermo-polyolefin, thermo-polyurethane, sprayed-urethane, foam-backed polyvinyl chloride and foam-backed thermo-polyolefin.

4. The instrument panel section of claim 1, wherein said layer of foam is a layer of urethane foam.

5. The instrument panel section of claim 1, wherein said first surface is adhesively bondable to the retainer by a reactive water based polyurethane hot melt adhesive.

6. The instrument panel section of claim 1, further comprising a skin lock contour on said first end, said skin lock contour being lockable with a matching skin lock contour of a second end of an adjacent instrument panel section.

7. The instrument panel section of claim 1, further comprising a flap of skin that extends beyond said second end, wherein said flap of skin is tuckable underneath a first surface of an adjacent instrument panel section such that said flap of skin is wrapable about a connecting protrusion of said adjacent instrument panel section and is receivable in said locator hole.

8. The instrument panel section of claim 7, further comprising an aperture in said flap of skin such that said connecting protrusion of said adjacent instrument panel section is extendable through said aperture and is receivable in said locator hole.

9. An instrument panel assembly connected to an instrument panel retainer of a vehicle, comprising:
a first instrument panel section including a layer of foam with a first surface, a second surface, and a first end; a skin including a first exterior surface and an interior surface, said interior surface being bonded to said second surface and said skin being wrapped around and bonded to said first end; and at least ore connecting protrusion extending from said first surface adjacent said first end; and
a second instrument panel section including a layer of foam with a first surface, a second surface, and a second end; a skin including a second exterior surface and an interior surface, wherein said second exterior surface is different than said first exterior surface, said interior surface being bonded to said second surface, and said skin being wrapped around and bonded to said second end defining a flap of skin,
wherein said first end abuts said second end, said flap of skin is tucked under said first end, said first surface of said first instrument panel section being adhesively bonded to the retainer, said first surface of said second instrument panel section being adhesively bonded to the retainer, said flap of skin wraps about said at least one connecting protrusion, and said flap of skin and said connecting protrusion being received in a locator hole of the retainer.

10. The instrument panel assembly of claim 9, wherein said second exterior surface is different from said first exterior surface by a feature selected from the group consisting of color, texture, material, and die-draw.

11. The instrument panel assembly of claim 9, wherein said at least one connecting protrusion is integral with and part of said layer of foam.

12. The instrument panel assembly of claim 9, wherein said skin is selected from the group consisting of polyvinyl chloride based vinyl, thermo-polyolefin, thermo-polyurethane, sprayed-urethane, foam-backed polyvinyl chloride and foam-backed thermo-polyolefin.

13. The instrument panel assembly of claim 9, wherein said layer of foam is a layer of urethane foam.

14. The instrument panel assembly of claim 9, wherein said first surface of said first instrument panel section and of said second instrument panel section are adhesively bonded to the retainer by a reactive water based polyurethane hot melt adhesive.

15. The instrument panel assembly of claim 9, further comprising a first contour on said first end and a second contour on said second end, wherein said second contour interlocks said first contour.

16. The instrument panel assembly of claim 9, further comprising an aperture in said flap of skin, wherein said at least one connecting protrusion extends through said aperture into said locator hole.

17. A method of aligning and interconnecting a first instrument panel section and a second instrument panel section with a retainer of a vehicle, comprising:
abutting a first end of a first instrument panel section with a second end of a second instrument panel section, wherein said first instrument panel section includes a layer of foam having a first surface and a second surface; a skin including a first exterior surface and an interior surface, said interior surface being bonded to said second surface and said skin being wrapped around and bonded to said first end; and at least one connecting protrusion extending from said first surface adjacent said first end, said second instrument panel section includes a layer of foam having a first surface, a second surface; a skin including a second exterior surface and an interior surface, said interior surface being bonded to said second surface and said skin being wrapped around and bonded to said second end such that a flap is defined;
tucking said flap of skin under said first end;
urging said connecting protrusion on said flap of skin and into a locator hole of the retainer to align and connect said first instrument panel section, said second instrument panel section and the retainer; and
bonding said first instrument panel section and said second instrument panel section to the retainer with an adhesive.

18. The method according to claim 17, further comprising the step of providing an aperture on said flap of skin before urging said at least one connecting protrusion extends through said aperture into said locator hole to align and connect said first instrument panel section, said second instrument panel section and the retainer.

19. The method according to claim 17, further comprising the step of providing said second exterior surface with a different a feature selected from the group consisting of color, texture, material and die-draw from said first exterior surface.

20. The method according to claim 17, wherein said at least one connecting protrusion is integral with and part of said layer of foam, said skin is selected from the group consisting of polyvinyl chloride based vinyl, thermo polyolefin, thermo-polyurethane, sprayed-urethane, foam-backed polyvinyl chloride and foam-backed thermo-polyolefin, said layer of foam is a layer of urethane foam, and said adhesive is a reactive water based polyurethane hot melt adhesive.
